(19) United States
(12) Patent Application Publication
(10) Pub. No.: US 2025/0035760 A1
(43) Pub. Date: Jan. 30, 2025

(54) FMCW LiDAR using single-photon detectors

(71) Applicant: Apple Inc., Cupertino, CA (US)

(72) Inventors: Shingo Mandai, Mountain View, CA (US); Cristiano L. Niclass, San Jose, CA (US); Vyshakh Sanjeev, San Francisco, CA (US)

(21) Appl. No.: 18/623,080

(22) Filed: Apr. 1, 2024

Related U.S. Application Data
(60) Provisional application No. 63/515,348, filed on Jul. 25, 2023.

(51) Int. Cl. G01S 7/4912; G01S 7/481; G01S 7/4915; G01S 17/34

(52) U.S. Cl. CPC G01S 7/4917; G01S 7/4816; G01S 7/4915; G01S 17/34

(57) ABSTRACT

Optical sensing apparatus includes a transmitter, which is configured to transmit outgoing frequency-modulated (FM) coherent optical radiation toward a target scene. A receiver includes an array of single-photon detectors, which are configured to output electrical pulses in response to photons that are incident on the detectors. Optics image the target scene onto the array while diverting a part of the outgoing FM coherent optical radiation to form a local beam, which mixes with incoming optical radiation from the target scene. Processing circuitry is configured to compute counts of the electrical pulses output as a function of time by the single-photon detectors in response to the mixed optical radiation, to extract beat frequencies from the computed counts, and to measure ranges of points in the target scene responsively to the beat frequencies.

### CROSS-REFERENCE TO RELATED APPLICATION

This application claims the benefit of U.S. Provisional Patent Application 63/515,348, filed Jul. 25, 2023, which is incorporated herein by reference.

### FIELD OF THE INVENTION

The present invention relates generally to systems and methods for optical sensing, and particularly to FMCW LiDAR sensing.

### BACKGROUND

In frequency-modulated continuous-wave (FMCW) LiDAR sensing arrangements, a radio-frequency (RF) chirp is applied to modulate the frequency of a beam of optical radiation (typically a single-mode laser beam) that is directed toward a target. The optical radiation reflected from the target is mixed with a sample of the transmitted light, referred to as a “local oscillator” or “local beam.” The mixed optical radiation is detected by a photodetector, such as a balanced photodiode pair, which then outputs an RF signal at a beat frequency that is proportional to the distance to the target. When the target is moving, the resulting Doppler shift of the reflected optical radiation will cause the beat frequency to increase or decrease, depending on the direction of motion.

By comparing the beat frequencies obtained from chirps of positive and negative slopes, it is thus possible to extract both the range and the velocity of the target. In the ideal case, if the beat frequency due to the Doppler shift is d, and the beat frequency due to the chirp and range is r, then the measured beat frequency for the up-chirp will be fᵤ=d+r, and the beat frequency on the down-chirp will be f_{d}=d−r. Thus, the sum of the measured up and down chirp frequencies reveals the Doppler shift, and the difference the range.

The terms “light” and “optical radiation,” as used in the context of the present description and in the claims, refer to electromagnetic radiation in any of the visible, ultraviolet, and infrared spectral bands.

### SUMMARY

Embodiments of the present invention that are described hereinbelow provide improved apparatus and methods for optical sensing.

There is therefore provided, in accordance with an embodiment of the invention, optical sensing apparatus, including a transmitter, which is configured to transmit outgoing frequency-modulated (FM) coherent optical radiation toward a target scene. A receiver includes an array of single-photon detectors, which are configured to output electrical pulses in response to photons that are incident on the detectors, and optics configured to image the target scene onto the array while diverting a part of the outgoing FM coherent optical radiation to form a local beam, which mixes with incoming optical radiation from the target scene. Processing circuitry is configured to compute counts of the electrical pulses output as a function of time by the single-photon detectors in response to the mixed optical radiation, to extract beat frequencies from the computed counts, and to measure ranges of points in the target scene responsively to the beat frequencies.

In some embodiments, the transmitter is configured to project the FM coherent optical radiation as flood radiation over a region of the target scene.

Alternatively, the transmitter is configured to project a pattern of the FM coherent optical radiation onto the target scene. In some embodiments, the processing circuitry is configured to select a subset of the single-photon detectors onto which the pattern is imaged by the optics, and to count the electrical pulses that are output by the single-photon detectors in the selected subset in order to detect the beat frequencies. In one embodiment, the pattern includes a matrix of spots. In another embodiment, the pattern includes one or more stripes.

In some embodiments, the transmitter is configured to apply a frequency chirp to the outgoing coherent optical radiation and to measure the ranges based on the beat signals that arise due to the frequency chirp.

In a disclosed embodiment, the single-photon detectors include single-photon avalanche diodes (SPADs).

In some embodiments, the processing circuitry is configured to compute the counts as collective counts of the electrical pulses output by respective groups of the single-photon detectors. In one embodiment, the processing circuitry is configured to sum the counts of the electrical pulses over the single-photon detectors in each of the groups.

In a disclosed embodiment, the counts of the electrical pulses as the function of time define temporal waveforms, and the processing circuitry is configured to extract the beat frequencies by transforming the temporal waveforms to a frequency domain representation and finding peaks in the frequency domain representation.

Additionally or alternatively, the processing circuitry is coupled to write the counts of the electrical pulses over a sequence of sub-frames in first and second pulse train buffers in alternation, and to read out the counts from the second and first pulse train buffers in a counter-alternation for processing to detect the beat frequencies, such that during each sub-frame, the counts of the electrical pulses are written to one of the first and second pulse train buffers and are read out of the other of the first and second pulse train buffers.

There is also provided, in accordance with an embodiment of the invention, a method for optical sensing, which includes transmitting outgoing frequency-modulated (FM) coherent optical radiation toward a target scene. The target scene is imaged onto an array of single-photon detectors, which output electrical pulses in response to photons that are incident on the detectors. A part of the outgoing FM coherent optical radiation is diverted to form a local beam, which mixes at the single-photon detectors with incoming optical radiation from the target scene. Counts are computed of the electrical pulses output as a function of time by the single-photon detectors in response to the mixed optical radiation. Beat frequencies are extracted from the computed counts, and ranges of points in the target scene are measured responsively to the beat frequencies.

The present invention will be more fully understood from the following detailed description of the embodiments thereof, taken together with the drawings in which:

### BRIEF DESCRIPTION OF THE DRAWINGS

FIG. 1 is a schematic pictorial view of an optical sensing apparatus, configured to operate as part of a LiDAR system, in accordance with an embodiment of the invention;

FIG. 2A is a frontal view of a SPAD array, in accordance with an embodiment of the invention;

FIG. 2B is a block diagram showing functional elements of a receiver, including a SPAD array, in accordance with an embodiment of the invention;

FIG. 2C is an electrical circuit diagram showing details of a pixel in a SPAD array, in accordance with an embodiment of the invention;

FIG. 3A is a schematic pictorial view of an optical sensing apparatus, in accordance with another embodiment of the invention;

FIG. 3B is a schematic pictorial view of an optical sensing apparatus, in accordance with an alternative embodiment of the invention;

FIG. 4 is a schematic pictorial view of an optical sensing apparatus, in accordance with yet another embodiment of the invention;

FIG. 5A is a block diagram showing components of an array of SPADs and associated control circuitry, in accordance with an embodiment of the invention;

FIG. 5B is a schematic diagram showing sampling and summation circuits in the array of FIG. 5A, in accordance with an embodiment of the invention;

FIG. 5C is a schematic circuit diagram showing details of a group of pixels in the array of FIG. 5A, in accordance with an embodiment of the invention;

FIG. 6 is a timing diagram that schematically illustrates the operation of a single superpixel in the array of FIG. 5A, in accordance with an embodiment of the invention;

FIG. 7 is a timing diagram that schematically illustrates the operation of control, counting, and readout circuits in the array of FIG. 5A, in accordance with an embodiment of the invention;

FIG. 8 is a block diagram, which schematically illustrates an array of pixels comprising SPADs with associated circuitry, in accordance with an embodiment of the invention;

FIG. 9A is a block diagram showing details of an array of pixels comprising SPADs and associated circuitry, in accordance with another embodiment of the invention; and

FIG. 9B is a timing diagram illustrating the operation of a sensing apparatus using the array and circuitry of FIG. 9A, in accordance with an embodiment of the invention.

### DETAILED DESCRIPTION

### Overview

In FMCW LiDAR systems that are known in the art, analog sensors, such as a balanced photodiode pair, are generally used to sense the mixed optical radiation and generate the RF beat signals. To enable digital detection of the beat signal frequency, the weak sensor output is typically amplified, for example by a trans-impedance amplifier (TIA), and then digitized by an analog/digital converter (ADC). The TIA and ADC occupy large areas on the sensor chip and consume substantial electrical power. Furthermore, the TIA itself adds substantial thermal noise to the sensor output, thus reducing the sensitivity of the LiDAR system to weak reflections, for example from distant targets. To overcome this added noise, some FMCW LiDAR systems increase the optical power of the local beam, which can improve the signal/noise ratio (SNR) but increases the overall power consumption even further.

Embodiments of the present invention that are described herein overcome these limitations by using single-photon detectors, such as single-photon avalanche diodes (SPADs), to detect the mixed optical radiation. Single-photon detectors are, in a sense, digital detectors, in that their output is binary: They output an electrical pulse in response to each incident photon that they sense. The beat frequency can be captured simply by counting the electrical pulses as a function of time and finding the frequency peaks in the temporal digital waveform that is defined by the succession of count values (for example by transforming the waveform computationally to the frequency domain).

The use of the single-photon detectors in this manner obviates the need for an analog amplifier and ADC and thus eliminates the attendant noise and consumption of electrical power and chip area. This single-photon detection approach is particularly advantageous in coherent sensing arrays, since it facilitates reduction of the pixel pitch, chip area, and power budget. The counters used to generate the digital waveform can be implemented using simple digital logic circuits, without the need for a high-frequency ADC. Such counters can operate at high frequencies, in the gigahertz range, and thus achieve high bandwidth and frequency precision, which translate into a large LiDAR detection range and more accurate range measurement. In some embodiments, the chip area can be reduced even further by stacking the detector array chip over a matching logic chip that includes the counting, switching, and readout circuits. Furthermore, because of the lower noise floor, FMCW LiDAR systems based on single-photon detectors can work with low-power local beams, possibly based on stray reflections within the system, rather than requiring a dedicated local beam channel.

Thus, in the embodiments that are described herein, optical sensing apparatus comprises a transmitter, which transmits outgoing frequency-modulated (FM) coherent optical radiation toward a target scene. In the embodiments described below, the frequency modulation is assumed to comprise a frequency chirp for purposes of range sensing, but alternatively, the principles of these embodiments may be applied, mutatis mutandis, using other modes of frequency modulation. The FM coherent optical radiation may be projected as flood radiation over an entire region of the target scene; or alternatively, it may be projected over limited areas, for as example as a pattern of spots or stripes.

The apparatus also comprises a receiver, comprising an array of single-photon detectors, such as SPADS, which output electrical pulses in response to photons that are incident on the detectors. Optics image the target scene onto the array while diverting a part of the outgoing FM coherent optical radiation to form a local beam. This local beam mixes with incoming optical radiation from the target scene and gives rise to a beat frequency in the mixed optical radiation, which is sensed by the single-photon detectors. When the transmitter projects patterned radiation, only the subset of the single-photon detectors onto which the pattern is imaged by the optics need be used in sensing the beat frequency.

Processing circuitry computes counts of the electrical pulses output by the single-photon detectors as a function of time in response to the mixed optical radiation and extracts the beat frequencies from the computed counts. The beat frequencies can then be applied in measuring ranges and velocities of points in the target scene from which the incoming optical radiation was received.

### System Description

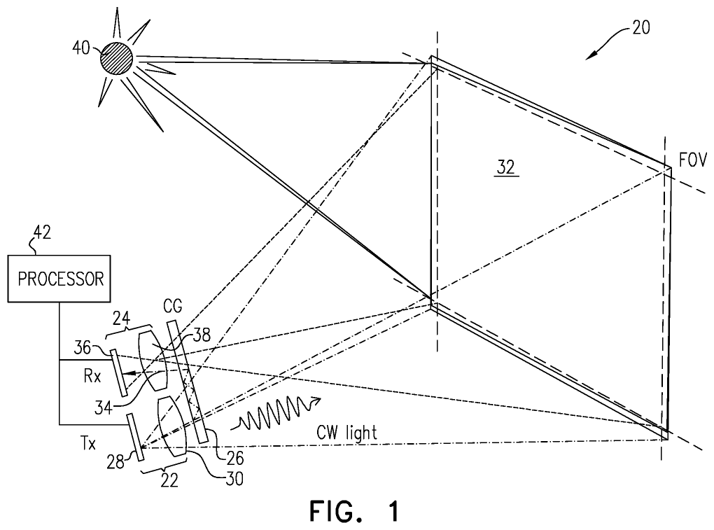

FIG. 1 is a schematic pictorial view of an optical sensing apparatus 20, configured to operate as part of a LiDAR system, in accordance with an embodiment of the invention. The apparatus comprises a transmitter (Tx) 22 and a receiver (Rx) 24, which are contained in an enclosure (not shown) with a cover glass (CG) 26.

Transmitter 22 comprises a modulated laser source 28 including suitable drive circuits, along with optics 30. The transmitter transmits outgoing FMCW coherent optical radiation as flood radiation, extending over an entire field of view (FOV) 32 of the apparatus in a target scene. A small part of the transmitted radiation is diverted by cover glass 26 to form a local beam 34, which is incident on receiver 24. In the pictured examples, local beam 34 is guided within cover glass 26 to the receiver. Alternatively, the local beam may be diverted toward the receiver from other optical elements or surfaces in the apparatus, or it may be separated from the outgoing radiation by a dedicated optical surface or light guide.

Receiver 24 comprises an array 36 of SPADs, as described in greater detail hereinbelow. An objective lens 38 images the part of the target scene that is within FOV 32 of the apparatus onto SPAD array 36. The incoming optical radiation from the target scene is mixed by the optics with the local beam, and the mixed radiation is incident on the SPADs in array 36. Interference between the FM coherent radiation reflected from the target scene and the FM local beam gives rise to an optical beat signal at the SPAD array. Photons of ambient radiation (represented by a light source 40 in the upper part of the figure) that is reflected from FOV 32 will also cause the SPADs to output electrical pulses, but without any distinct beat frequency.

A processor 42 controls the operation of transmitter 22 and receiver 24 and also receives the digital waveforms corresponding to the counts of SPAD pulses that are output by the receiver. Processor 42 extracts the beat frequencies from the digital waveform generated by each pixel of SPAD array 36 and uses the beat frequency at each pixel in measuring the range from the apparatus to a point in the target scene that is imaged onto the pixel. (A “pixel” may comprise a single SPAD or a group of neighboring SPADs, as described further hereinbelow.) Processor 42 may also compute velocities of the points in the target scene based on the up-chirp and down-chirp beat frequencies, as explained above. The processor typically comprises a programmable microprocessor or microcontroller with suitable interfaces to the other components of the apparatus. Alternatively or additionally, at least some of the functions of the processor may be carried out by a special-purpose digital signal processor and/or by other digital logic, which may be hard-wired or programmable.

In the embodiments that are described below, processor 42 performs the functions described herein in conjunction with digital logic circuits that are integrated with SPAD array 36. The processor and the digital logic circuits are referred to collectively in the present description and in the claims as “processing circuitry.” The processor itself is omitted from the figures that follow for the sake of simplicity.

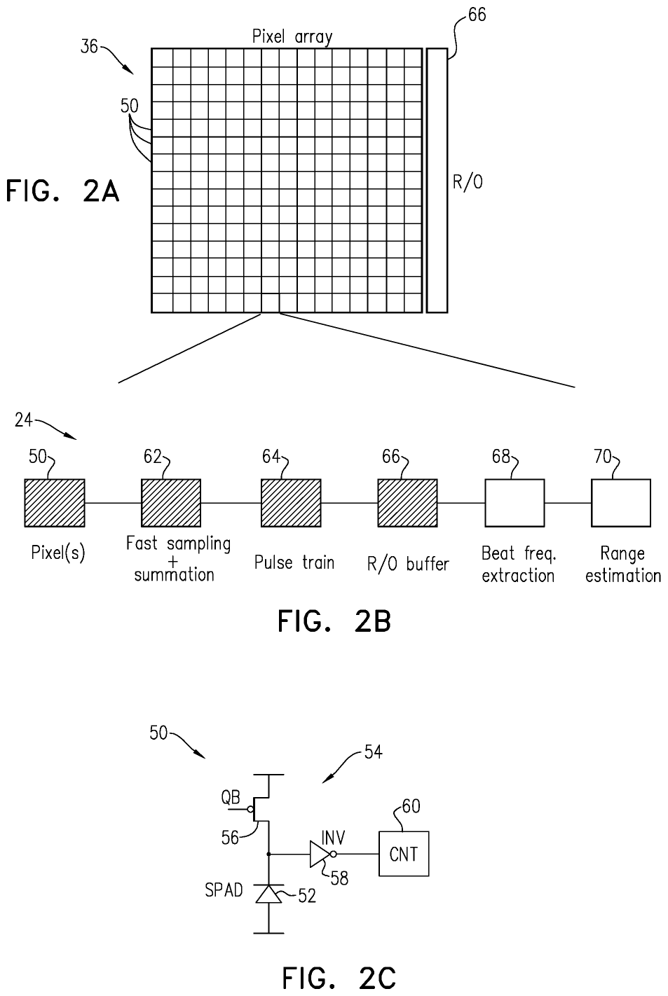

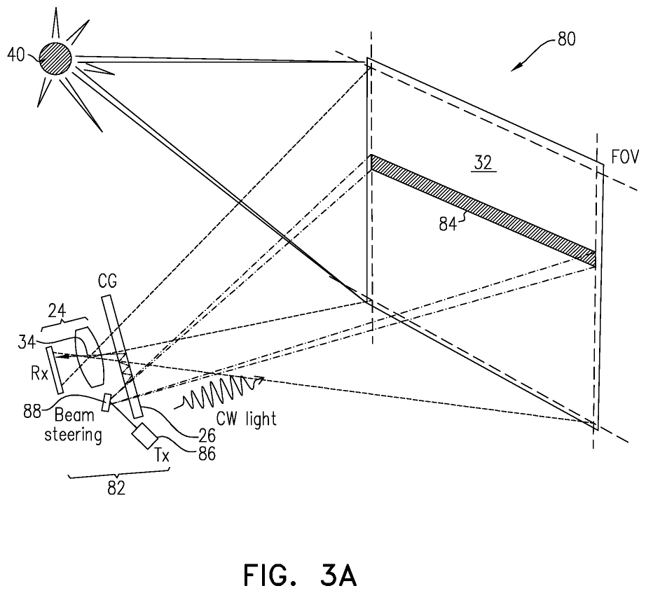

Reference is now made to FIGS. 2A-C, which schematically show details of SPAD array 36, which can be used as part of receiver 24 in apparatus 20 (FIG. 1), in accordance with an embodiment of the invention. FIG. 2A is a frontal view of SPAD array 36. FIG. 2B is a block diagram showing functional elements of receiver 24, including the SPAD array. FIG. 2C is an electrical circuit diagram showing details of one of pixels 50 in SPAD array 36.

SPAD array 36 in this embodiment comprises two chips, stacked one over the other: an upper chip containing the SPADs and a lower chip containing the associated logic circuits for each pixel 50. The upper chip may be configured for back-side illumination (BSI) of the SPADS, i.e., with the back side of the chip facing outward, while the front side of this SPAD chip is bonded to the logic chip. The upper chip contains array 36 of SPADs 52 with associated bias and quenching circuits 54, for example as shown in FIG. 2C. To conserve power, the bias may be switched on and off by a gate 56 (QB).

Each pixel 50 of the logic chip in this example comprises an inverter 58 followed by a counter 60, which counts the pulses output by the SPAD 52. Alternatively, each counter 60 may be shared among a group of neighboring pixels 50, for example by summing or multiplexing of the output pulses as shown below. As shown in FIG. 2B, fast sampling and summation circuits 62 count the electrical pulses output by each of pixels 50 as a function of time (via inverter 58) and generate a corresponding digital pulse train 64. This pulse train defines a temporal digital waveform comprising a sequence of time bins with a duration determined by the sampling time and an amplitude in each bin equal to the pulse count accumulated in the bins over a predefined time period. The waveform is stored in a readout (R/O) buffer in each pixel or group of pixels and then read out to a processor external to the pixel array, for example processor 42 (FIG. 1). The external processor extracts beat frequencies 68 from the digital waveforms and applies the beat frequencies in estimating ranges 70 of points in the target scene.

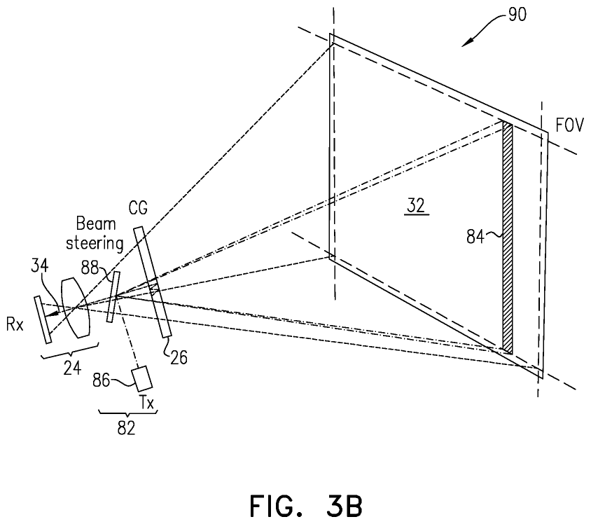

FIG. 3A is a schematic pictorial view of an optical sensing apparatus 80, in accordance with another embodiment of the invention. This apparatus is similar to apparatus 20 (FIG. 1), except that in the present embodiment, a transmitter 82 transmits the FMCW radiation in the form of a stripe 84. For example, transmitter 82 may comprise a laser 86 with cylindrical optics (not shown), which spread the beam across the scene along a stripe axis (which is horizontal in the pictured embodiment). A beam steering unit 88, comprising a scanning mirror for example, scans the stripe across the scene in a direction perpendicular to the stripe axis (vertically in this embodiment). Alternatively, other beam steering devices and other sorts of scan patterns may be used.

Notwithstanding the change in transmitter 82, receiver 24 in this embodiment may be substantially similar to that described above with reference to FIGS. 2A-C. In this case, however, the biasing and logic circuits can be synchronized with the scan of the beam across the scene, so that only the pixels that capture photons from the area illuminated by the stripe at any given moment are turned on, and only the pulses output by these pixels are counted. This approach can improve the SNR and/or reduce the power consumed by the apparatus relative to the flood configuration of FIG. 1.

FIG. 3B is a schematic pictorial view of an optical sensing apparatus 90, in accordance with an alternative embodiment of the invention. This apparatus is similar to apparatus 80 (FIG. 3A), except that in the present embodiment, the transmit axis of a transmitter 92 and the receive axis of receiver 24 are coincident, rather than offset transversely as in FIG. 3A. This sort of coaxial arrangement of transmitter 92 and receiver 24 can similarly be applied to apparatus using flood-based illumination (as in FIG. 1) or other patterned illumination (such as a matrix of spots as described below).

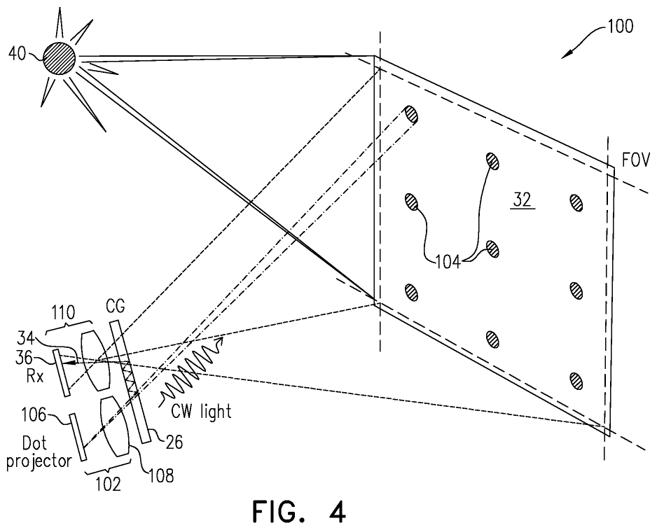

FIG. 4 is a schematic pictorial view of an optical sensing apparatus 100, in accordance with yet another embodiment of the invention. This apparatus is again similar to apparatus 20 (FIG. 1), but in the present case, a transmitter 102 transmits the FMCW radiation as a matrix of spots 104. For example, the transmitter may comprise a laser 106 together with suitable optics 108, such as a diffractive optical element, which split the beam into multiple spots 104. A receiver 110 is again similar to that described above, but the biasing and logic circuits can be controlled so that only the pixels in array 36 that capture photons from the areas illuminated by the spots are turned on, and only the pulses output by these pixels are counted. This approach, too, can improve the SNR and/or reduce the power consumed by the apparatus relative to the flood configuration of FIG. 1.

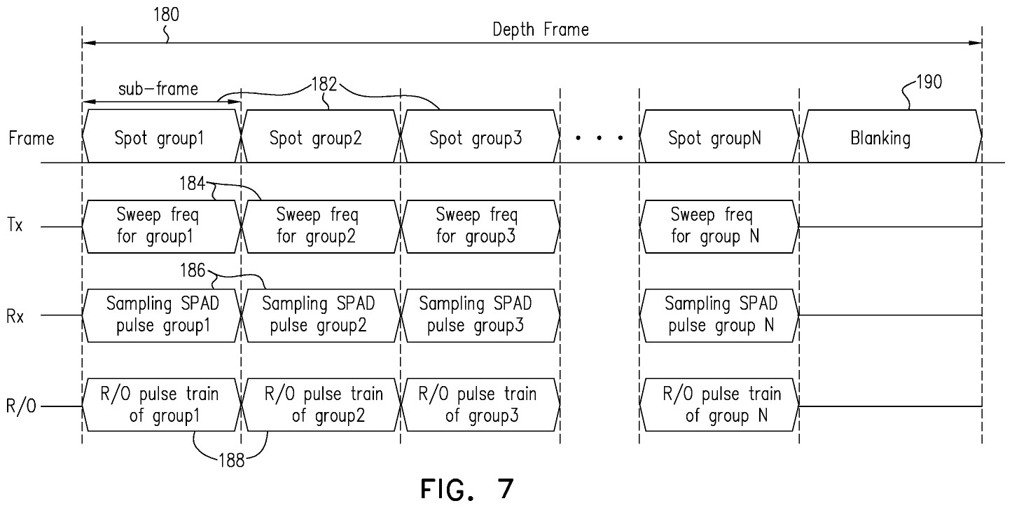

All spots 104 in apparatus 100 may be turned on simultaneously or, alternatively, different groups of spots may be turned on, together with the corresponding detector pixels, at different times. This latter approach is advantageous in enabling the sampling, summation and readout circuits to be shared by time-multiplexing among the corresponding groups of pixels. A multiplexing scheme of this sort is shown in FIG. 7, for example.

### PROCESSING CIRCUITRY

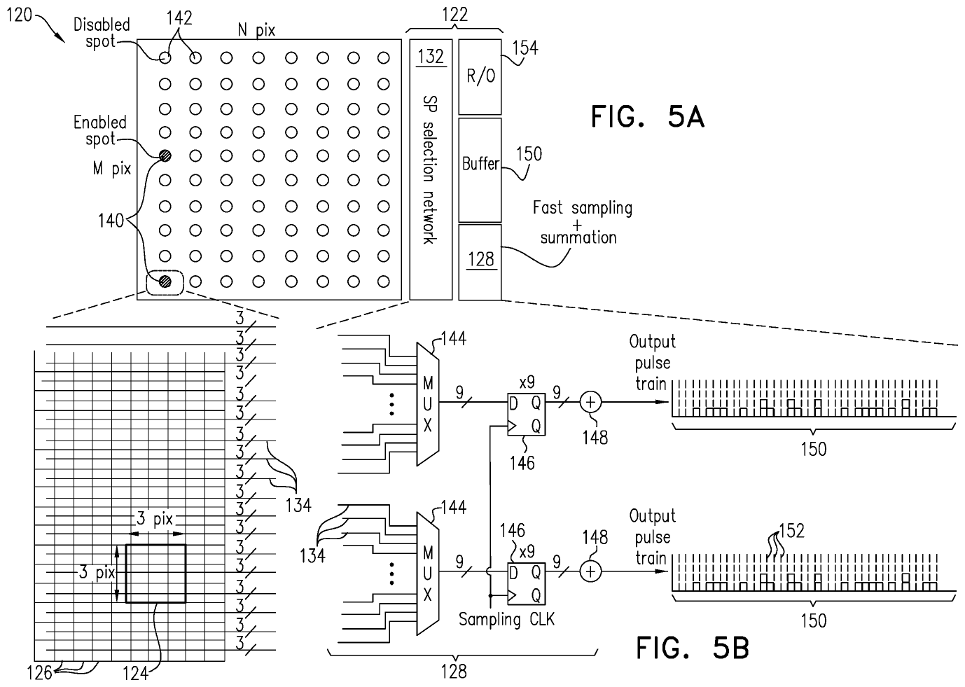

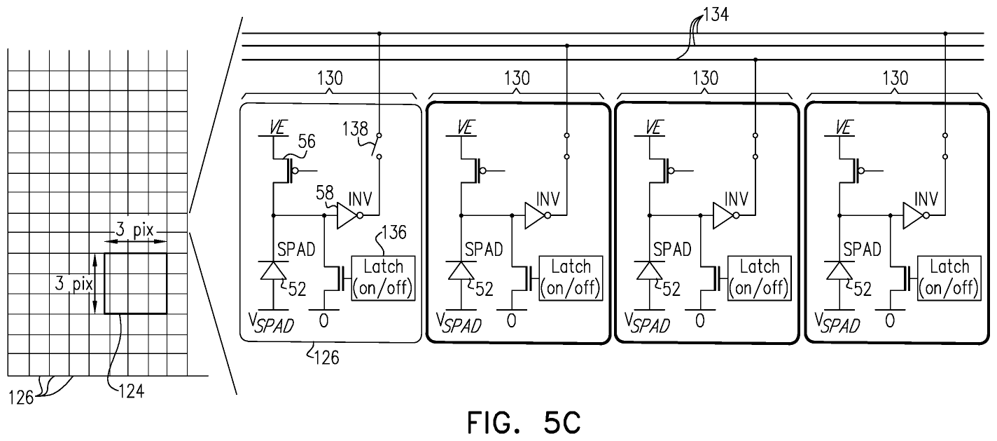

Reference is now made to FIGS. 5A-5C, which schematically illustrate an array 120 of SPADs 52 with associated processing circuitry, which may be used in receiver 110 (FIG. 4), in accordance with an embodiment of the invention. FIG. 5A is a block diagram showing the components of array 120 and control circuitry 122, while FIGS. 5B and 5C are schematic circuit diagrams showing details of a group 124 of pixels 126 and corresponding sampling and summation circuits 128 in the array. The principles of operation of the array of FIGS. 5A-C are similar to those of the embodiment of FIGS. 2A-2C, with adaptations for efficient operation in conjunction with a transmitter 102 that projects spot illumination onto the target scene.

Array 120, as shown in FIG. 5A, comprises a matrix of SPADs 52, with bias and pixel control circuits 130 as shown in FIG. 5C and sampling and summation circuits 128 as shown in FIG. 5B. Although control circuitry 122 and pixel control circuits 130 are shown alongside SPADs 52 in pixel array 120 for the sake of clarity, these circuits may conveniently be implemented, at least in part, in a control chip that is stacked below the SPAD array chip as in the embodiment of FIGS. 2A-2C.

A superpixel (SP) selection network 132 comprises switching circuits for activating and receiving signals from certain groups of SPADS 52, specifically the SPADS onto which spots 104 projected onto the target scene are imaged by the receiver optics (FIG. 4). In the pictured example, these groups (superpixels) are assumed to comprise groups 124 of nine SPADs each, in a 3×3 arrangement. SP selection network 132 comprises three buses 134 in each row of pixels 126 in array 120, along with switches 136, 138 to select SPADs 52 that are to be latched on and connected to bus 134 for readout (FIG. 5C). In this manner, superpixels 140 on which spots 104 are images are enabled, while the remaining superpixels 142 are disabled (FIG. 5A).

As shown in FIG. 5B, fast sampling and summation circuits 128 comprise multiplexers 144, which select the active buses 134 from which pulses are to be received and counted. Sampling circuits 146, for example flipflops in the present embodiment, sample and count the electrical pulses that are output as a function of time from SPAD 52 in each selected superpixel 140. Summation circuits 148 sum the counts of pulses output by all the SPADs in the group in time bins 152 that are defined by a sampling clock, and write the count values over time to a buffer 150. The digital waveforms that are stored to the buffer thus represent the total count in each time bin 152 over all the pixels in the group. A readout circuit 154 reads out the digital waveforms from the buffer to processor 42 (FIG. 1), which extracts the beat frequencies and computes corresponding range values.

In an alternative embodiment, the counts output by sampling circuits 146 are not summed together. Rather, the counts from each pixel 126 are output to a dedicated buffer. This configuration requires increased buffer space but can yield improved measurement precision.

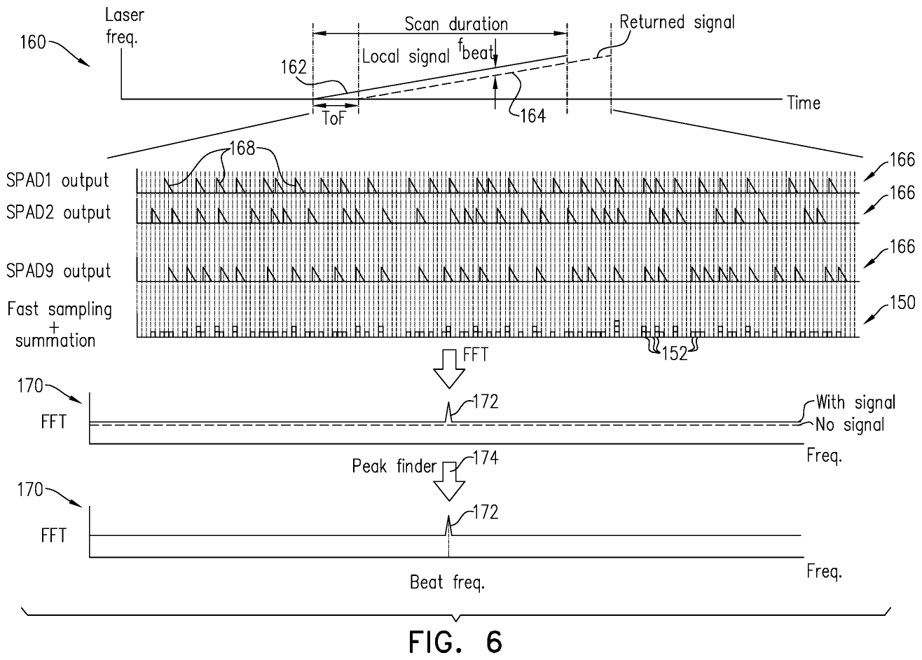

FIG. 6 is a timing diagram that schematically illustrates the operation of a single superpixel 140 in array 120 (FIGS. 5A-C), in accordance with an embodiment of the invention. An upper plot 160 in the figure shows a frequency chirp 162 over time that is applied to the outgoing transmitted and local beams by transmitter 102 (FIG. 4), together with a corresponding delayed frequency chirp 164 of the incoming optical radiation that has been reflected from the target scene. The temporal offset between outgoing and incoming chirps 162 and 164 is equal to the time of flight (ToF) of the photons, and it gives rise to an optical beat signal at a frequency f_{beat} that is equal to the instantaneous frequency difference between the outgoing and incoming radiation.

Each of the SPADs in a given superpixel group (labeled SPAD1, SPAD2, . . . , SPAD9) outputs a sequence 166 of pulses 168 in response to incident photons. Typically, most of the pulses are due to ambient light and will thus have a random distribution over time with a flat frequency spectrum. A small fraction of the pulses, however, will be due to the optical beating between the outgoing and incoming radiation and will give rise to a peak 172 in a frequency spectrum 170 at the beat frequency. To find this beat frequency, fast sampling and summation circuits 128 (FIG. 5A) count the total number of pulses output by SPADS 52 in the superpixel group as a function of time and store the counts in corresponding time bins 152. The width of the bins is selected depending on the desired range resolution and may be 1 ns or less, for example. Sampling and summation circuits 128 output a digital temporal waveform defined by the sequence of count values over time in buffer 150, as shown in FIG. 6.

To extract the beat frequency at each superpixel, processor 42 (FIG. 1) converts the temporal waveform to the frequency domain, for example by computing a fast Fourier transform (FFT) over the waveform, giving frequency spectrum 170. Processor 42 then applies a peak-finding algorithm 174 to find the frequency bin with the maximum amplitude. Processor 42 verifies that the shape of this peak 172 in the frequency domain matches the expected shape of the beat signal, for example using a matching filter. Processor 42 converts this frequency to a range value for the corresponding spot location in the target scene. In some cases, multiple peaks may be found. Furthermore, although FIG. 6 shows only a single, upward frequency chirp 162, transmitter 102 may alternatively apply a down-chirp as well to enable the processor to find target scene velocities, as well.

FIG. 7 is a timing diagram that schematically illustrates the operation of the control, counting, and readout circuits in array 120 (FIG. 5A), in accordance with an embodiment of the invention. This embodiment assumes that different groups of spots 104 (as shown in FIG. 4, identified as spot groups 1 through N) are illuminated at different times during each range measurement frame.

Each range sensing frame 180 is divided into N sub-frames 182. During each sub-frame 182, transmitter 102 illuminates the corresponding group of spots 104, while sweeping the modulation frequency over the chirp range, in a sweep interval 184. During each sub-frame 182, the corresponding group of SPADs 52 in receiver 110, onto which the spots in the group are imaged by optics 38, is turned on, so that the SPADs output trains of pulses; and sampling and summation circuits 128 generate corresponding digital temporal waveforms over a corresponding sampling interval 186. At the end of each sub-frame 182, readout circuits 154 read out these waveforms during a readout period 188 to processor 42 for extraction of the beat frequency. Frame 180 ends with a blanking period 190.

In the embodiment shown in FIG. 7, the readout takes place immediately within or at the conclusion of each sub-frame 182. This configuration can necessitate a delay between sub-frames (not shown in the figure) to complete the readout before overwriting the results in buffer 150.

Alternatively, the readout circuits may comprise dual pulse train buffers, to which the sampling and summation circuits write the digital temporal waveforms in alternation, while the readout circuits read out the counts from the two pulse train buffers to the processor in counter-alternation. In other words, during each sub-frame, the sampling and summation circuits write the counts of the electrical pulses to one of the pulse train buffers, while the readout circuits simultaneously read out the digital temporal waveform of the previous sub-frame from the other pulse train buffer. In the next sub-frame, the write and read functions are swapped between the two buffers.

This double-buffering scheme makes it possible to read out and process the digital temporal waveforms continuously at the full acquisition speed. The figures that follow show examples of double-buffering schemes of this sort.

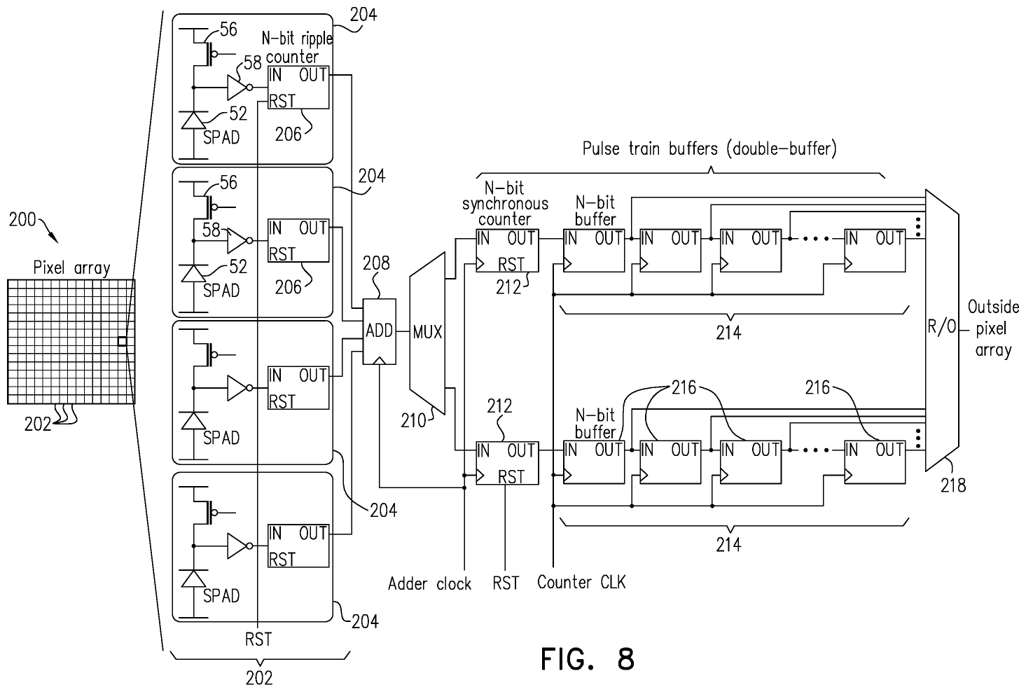

FIG. 8 is a block diagram, which schematically illustrates an array 200 of pixels 202 comprising SPADs 52 with associated processing circuitry, in accordance with an embodiment of the invention. This embodiment is suitable for use particularly in conjunction with the flood illumination scheme of FIG. 1 or the stripe illumination scheme of FIGS. 3A/B. It uses a double-buffering scheme to enable simultaneous generation and readout of digital temporal waveforms over a succession of sub-frames. Typically, each sub-frame corresponds to the period over which the transmitter performs a single chirp, i.e., applies a single sweep of the modulation frequency to the transmitted beam.

In the embodiment of FIG. 8, each pixel 202 comprises a group of four sub-pixels 204, comprising respective SPADS 52 and respective ripple counters 206 to count the pulses output by the SPAD in each time bin (controlled by a reset clock—RST). An adder 208 sums the outputs of ripple counters 206, and a multiplexer 210 passes the output pulses to a pair of synchronous counters 212 in alternation. Counters 212 pass the pulse counts into respective pulse train buffers 214. Thus, the counters, adders, and pulse train buffers receive and write data in alternation over the succession of sub-frames.

Each pulse train buffer 214 comprises a series of bin buffers 216. The count values are clocked through bin buffers 216 over the sequence of time bins with a clock period equal to the temporal width of the bins. Thus, at the end of any given sub-frame, each bin buffer 216 stores the pulse count for this pixel 202 in a respective time slot. In this way, during each sub-frame, the count values are written into one of pulse train buffers sequentially 214. During the next sub-frame, these values are read out of bin buffers 216 in parallel via a readout circuit 218, while the count values output by SPADs 52 are written to the other pulse train buffer 214. In other words, over the succession of sub-frames, the processing circuitry writes data to the two pulse train buffers 214 in alternation between the buffers and simultaneously reads out the data in counter-alternation between the buffers.

In an alternative embodiment (not shown in the figures), each sub-pixel 204 has its own, dedicated pair of pulse train buffers 214, fed by a respective multiplexer, without adding the pixel count values together. Processor 42 reads out and computes the frequency spectrum of each sub-pixel separately and may then combine the spectra in the frequency domain to find he beat frequencies, rather than in the time domain as shown in FIG. 8.

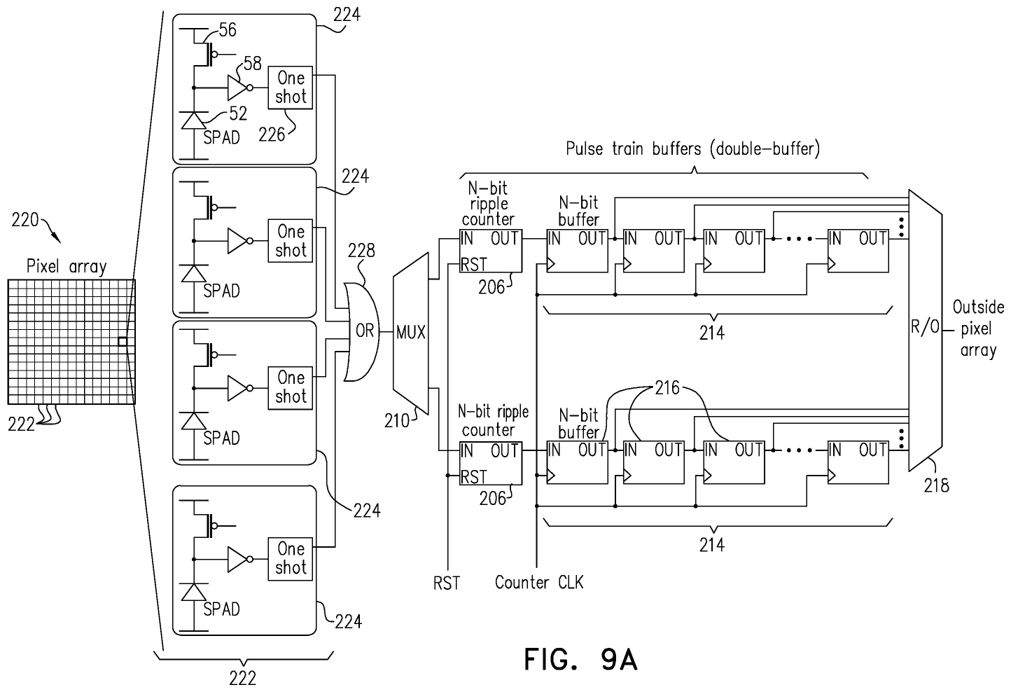

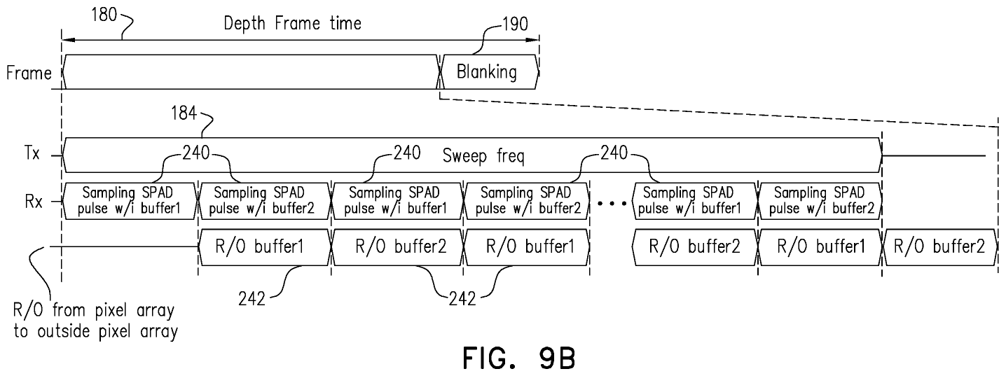

Reference is now made to FIGS. 9A and 9B, which schematically illustrate the operation of an array 220 of pixels 222 comprising SPADs 52 and associated processing circuitry, in accordance with an alternative embodiment of the invention. This embodiment is also suitable for use in conjunction with the flood illumination scheme of FIG. 1 or the stripe illumination scheme of FIGS. 3A/B. FIG. 9A is a block diagram showing details of array 220 and associated circuitry, while FIG. 9B is a timing diagram illustrating the operation of a sensing apparatus using the array and circuitry of FIG. 9A. As in the embodiment of FIG. 8, the processing circuitry in FIG. 9A uses a double-buffering scheme to enable simultaneous writing and readout of digital temporal waveforms over a succession of sub-frames.

Each pixel 222 in array 220 comprises a group of four sub-pixels 224, comprising respective SPADs 52 and one-shot pulse generators 226 to sharpen the electrical pulses that the SPADs output. The pulse outputs are joined into a single pulse stream by an OR gate 228. As in the preceding embodiment, multiplexer 210 directs the pulses to one of two pulse train buffers 214, operating in alternation over a succession of sub-frames 240, as shown in FIG. 9B. Each pulse train buffer 214 is fed by a respective ripple counter 206, so that at the end of the sub-frame, each bin buffer 216 stores the pulse count for this pixel in a respective time slot. During the next sub-frame, the pulse counts are read out of the bin buffers in parallel readout intervals 242 via readout circuit 218, while the count values output by SPADs 52 are written to the other pulse train buffer. This alternation is illustrated by the Rx and R/O functions shown in FIG. 9B.

The embodiments described above are cited by way of example, and the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Optical sensing apparatus, comprising:
a transmitter, which is configured to transmit outgoing frequency-modulated (FM) coherent optical radiation toward a target scene;
a receiver, comprising:
an array of single-photon detectors, which are configured to output electrical pulses in response to photons that are incident on the detectors; and
optics configured to image the target scene onto the array while diverting a part of the outgoing FM coherent optical radiation to form a local beam, which mixes with incoming optical radiation from the target scene; and
processing circuitry configured to compute counts of the electrical pulses output as a function of time by the single-photon detectors in response to the mixed optical radiation, to extract beat frequencies from the computed counts, and to measure ranges of points in the target scene responsively to the beat frequencies.

2. The apparatus according to claim 1, wherein the transmitter is configured to project the FM coherent optical radiation as flood radiation over a region of the target scene.

3. The apparatus according to claim 1, wherein the transmitter is configured to project a pattern of the FM coherent optical radiation onto the target scene.

4. The apparatus according to claim 3, wherein the processing circuitry is configured to select a subset of the single-photon detectors onto which the pattern is imaged by the optics, and to count the electrical pulses that are output by the single-photon detectors in the selected subset in order to detect the beat frequencies.

5. The apparatus according to claim 3, wherein the pattern comprises a matrix of spots.

6. The apparatus according to claim 3, wherein the pattern comprises one or more stripes.

7. The apparatus according to claim 1, wherein the transmitter is configured to apply a frequency chirp to the outgoing coherent optical radiation and to measure the ranges based on the beat signals that arise due to the frequency chirp.

8. The apparatus according to claim 1, wherein the single-photon detectors comprise single-photon avalanche diodes (SPADs).

9. The apparatus according to claim 1, wherein the processing circuitry is configured to compute the counts as collective counts of the electrical pulses output by respective groups of the single-photon detectors.

10. The apparatus according to claim 9, wherein the processing circuitry is configured to sum the counts of the electrical pulses over the single-photon detectors in each of the groups.

11. The apparatus according to claim 1, wherein the counts of the electrical pulses as the function of time define temporal waveforms, and wherein the processing circuitry is configured to extract the beat frequencies by transforming the temporal waveforms to a frequency domain representation and finding peaks in the frequency domain representation.

12. The apparatus according to claim 1, wherein the processing circuitry is coupled to write the counts of the electrical pulses over a sequence of sub-frames in first and second pulse train buffers in alternation, and to read out the counts from the second and first pulse train buffers in a counter-alternation for processing to detect the beat frequencies, such that during each sub-frame, the counts of the electrical pulses are written to one of the first and second pulse train buffers and are read out of the other of the first and second pulse train buffers.

13. A method for optical sensing, comprising:
transmitting outgoing frequency-modulated (FM) coherent optical radiation toward a target scene;
imaging the target scene onto an array of single-photon detectors, which output electrical pulses in response to photons that are incident on the detectors;
diverting a part of the outgoing FM coherent optical radiation to form a local beam, which mixes at the single-photon detectors with incoming optical radiation from the target scene;
computing counts of the electrical pulses output as a function of time by the single-photon detectors in response to the mixed optical radiation;
extracting beat frequencies from the computed counts; and
measuring ranges of points in the target scene responsively to the beat frequencies.

14. The method according to claim 13, wherein transmitting the outgoing FM coherent optical radiation comprises projecting the FM coherent optical radiation as flood radiation over a region of the target scene.

15. The method according to claim 13, wherein transmitting the outgoing FM coherent optical radiation comprises projecting a pattern of the FM coherent optical radiation onto the target scene.

16. The method according to claim 13, wherein transmitting the outgoing FM coherent optical radiation comprises applying a frequency chirp to the outgoing coherent optical radiation, wherein the ranges are measured based on the beat signals that arise due to the frequency chirp.

17. The method according to claim 13, wherein the single-photon detectors comprise single-photon avalanche diodes (SPADs).

18. The method according to claim 13, wherein computing the counts comprises computing collective counts of the electrical pulses output by respective groups of the single-photon detectors.

19. The method according to claim 13, wherein computing the counts comprises counting the electrical pulses output by each of the single-photon detectors individually.

20. The method according to claim 13, wherein the counts of the electrical pulses as the function of time define temporal waveforms, and wherein extracting the beat frequencies comprises transforming the temporal waveforms to a frequency domain representation and finding peaks in the frequency domain representation.
